(19) United States
(12) Patent Application Publication
(10) Pub. No.: US 2022/0272012 A1
(43) Pub. Date: Aug. 25, 2022

(54) DYNAMIC COMPOSITION OF DISAGGREGATED PROCESSES

(71) Applicant: Intel Corporation, Santa Clara, CA (US)

(72) Inventors: S M Iftekharul ALAM, Hillsboro, OR (US); Ned SMITH, Beaverton, OR (US); Vesh Raj SHARMA BANJADE, Portland, OR (US); Satish C. JHA, Portland, OR (US); Christian MACIOCCO, Portland, OR (US); Mona VIJ, Portland, OR (US); Kshitij A. DOSHI, Tempe, AZ (US); Srikathyayani SRIKANTESWARA, Portland, OR (US); Francesc GUIM BERNAT, Barcelona (ES); Maruti GUPTA HYDE, Portland, OR (US); Alexander BACHMUTSKY, Sunnyvale, CA (US)

(21) Appl. No.: 17/744,034

(22) Filed: May 13, 2022

(51) Int. Cl. H04L 43/0811; H04L 43/0882; H04L 43/091; H04L 43/062

(52) U.S. Cl. CPC H04L 43/0811; H04L 43/0882; H04L 43/091; H04L 43/062

(57) ABSTRACT

Examples described herein relate to dynamically composing an application as a monolithic implementation or two or more microservices based on telemetry data. In some examples, based on composition of an application as two or more microservices, at least one connection between microservices based on telemetry data is adjusted. In some examples, a switch can be configured to perform forwarding of communications between microservices based on the adjusted at least one connection between microservices.

### BACKGROUND

The Next G core network is a roadmap to implementation of next generation network systems from broadband networks to 6G wireless communications beyond 3GPP 5G wireless network capabilities. Next G is contemplated to be implemented using cloud-native microservices or serverless constructs for scalability, programmability and resiliency. Some 3GPP 5G user-plane functions (UPFs), however, have stringent reliability requirements (e.g., five nines) and low latency requirements. Fault and failure events in the infrastructure, however, can disrupt the performance of latency-sensitive network functions (e.g., UPF) by making hardware resources unavailable or causing congestion in a communications network.

### BRIEF DESCRIPTION OF THE DRAWINGS

FIG. 1A depicts an example system.

FIG. 1B depicts an example system.

FIG. 1C depicts an example of a resiliency control network (RCN).

FIG. 2 depicts an example of interface boundaries.

FIGS. 3A-3C depicts an example of modification of an interface boundary.

FIG. 4 depicts an example use of network interface device to manage interface boundaries between network functions.

FIG. 5 depicts an example of associating telemetry with processes.

FIG. 6 depicts an example system to trace telemetry data associated with process-to-process communications.

FIG. 7 depicts an example system.

FIG. 8 depicts an example process.

FIG. 9 depicts an example network interface device.

FIG. 10 depicts an example computing system.

### DETAILED DESCRIPTION

Latency-sensitive network functions can be implemented by (i) executing network functions as microservices by placing the inter-dependent microservices executed on a same server or same server and infrastructure processing unit (IPU), or (ii) using a monolithic implementation for the entire network function or the most time-sensitive critical parts of the network function. In an event of a fault or failure condition, in case of decomposing a network function into fine-grained but co-located microservices, finding an alternative set of resources with the same tight coupling properties can be challenging. In an event of a fault or failure condition, a monolithic implementation of a network function on a server can stall operation of the network function.

Network functions (NF), virtual functions (VF), container functions (CF), or function as a service (FaaS) utilize an orchestrator, scheduler, active-active redundancy, active-passive redundancy that detect function failure, assess the reason for failure, and attempt to recover from failure. The orchestrator, scheduler or other management controller that is supposed to resolve failures could be the victim of Fault-Attack-Failure-Outage (FAFO) events resulting in cascaded failures.

At least to provide for execution of cloud-native network functions (NFs) in accordance with applicable service level agreement (SLA) parameters, despite occurrences of device or network faults or failures, deployment of cloud-native network functions can change from execution on a single platform to execution on multiple platforms, or vice versa, based on telemetry data indicative of hardware device failure, network congestion, or expected imminent platform failure. Adjustment of one or more platform nodes that execute network functions and/or communication interfaces among executed network functions can be based on prediction of faults or failures in one or more platform nodes or communication network. Prediction of faults or failures in one or more platform nodes or communication network can be based on scale-out telemetry data and tracing. For example, failure can be predicted based on a trained machine learning (ML) or artificial intelligence (AI) model that correlates telemetry data with occurrences of failure or faults or identification of anomalistic conditions. The ML or AI model can continue to re-train based on received telemetry to reduce false positives. Other adjustments based on prediction of faults or failures can include one or more of: adjust communications paths, back-up state of executed NF, provide redundancy of an NF, security assessment of a node and so forth.

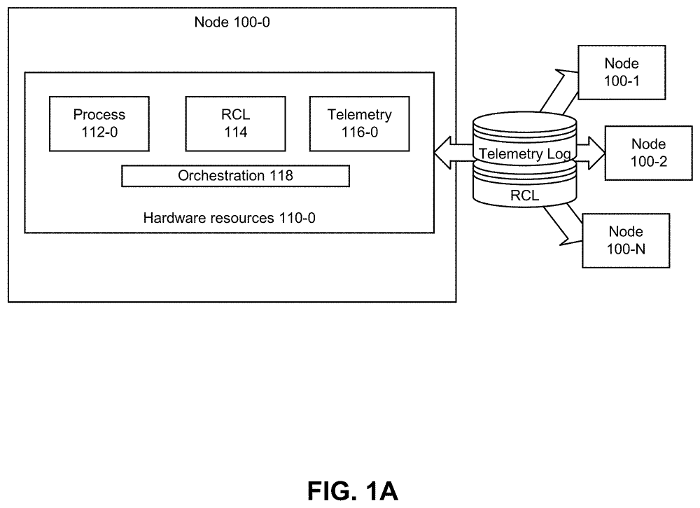

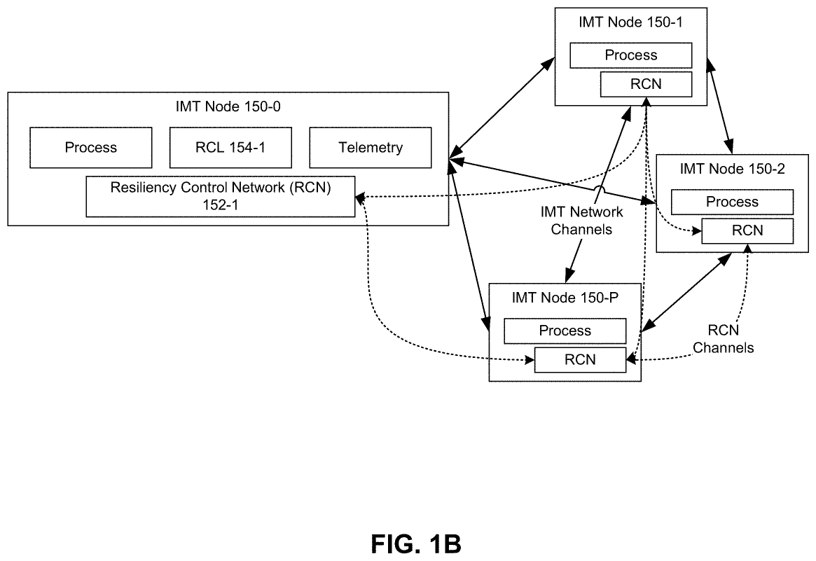

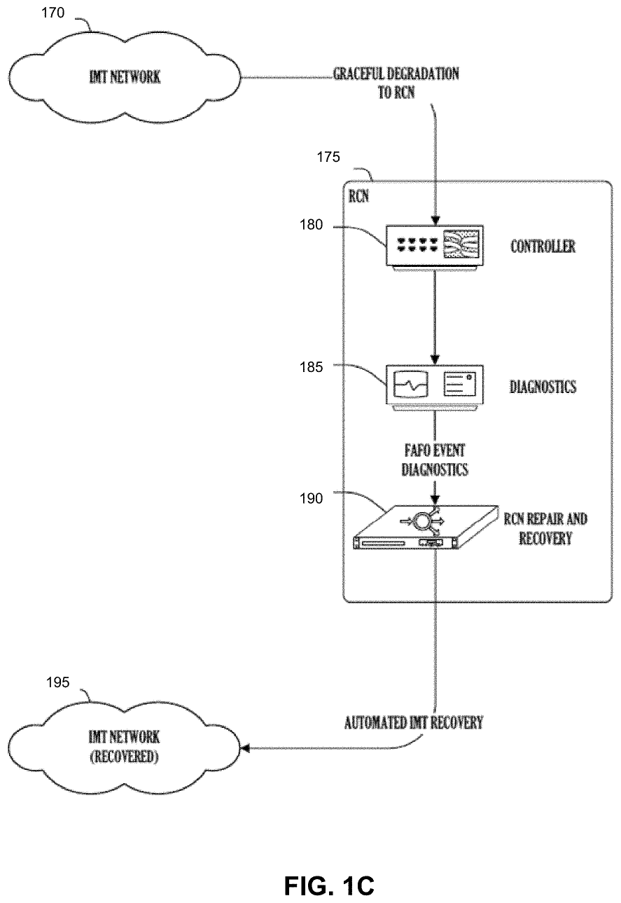

FIG. 1A depicts an example system. Nodes 100-0 to 100-N can communicate to selectively adjust a node that executes a process and/or a communication interface. In some examples, N is an integer of 3 or more. Node 100-0 can include hardware resources 110-0 that execute process 112-0 and orchestration 118. Node 100-0 can store and analyze Reliability Checkpoint Logging (RCL) 114-0 and telemetry data 116-0 to determine whether a fault or failure is occurring or expected to occur. Nodes 100-1 to 100-N can be implemented similarly to node 100-0.

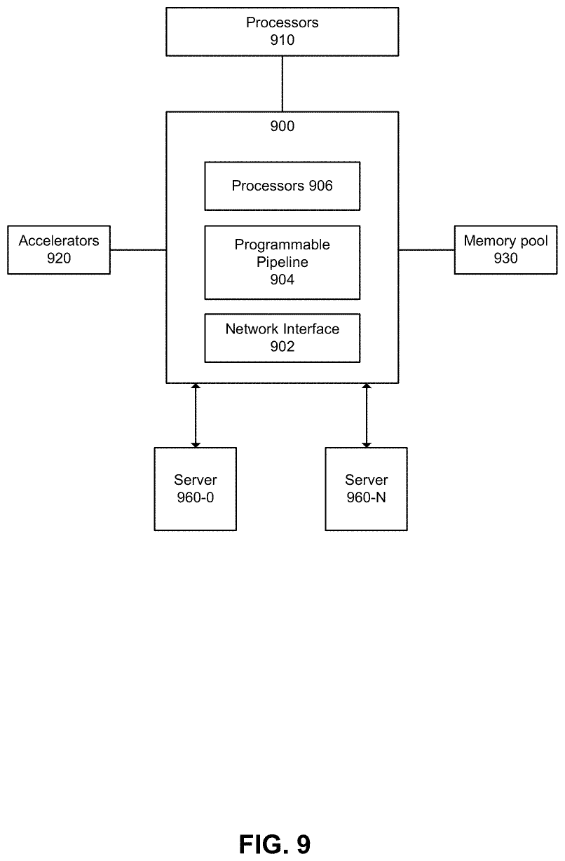

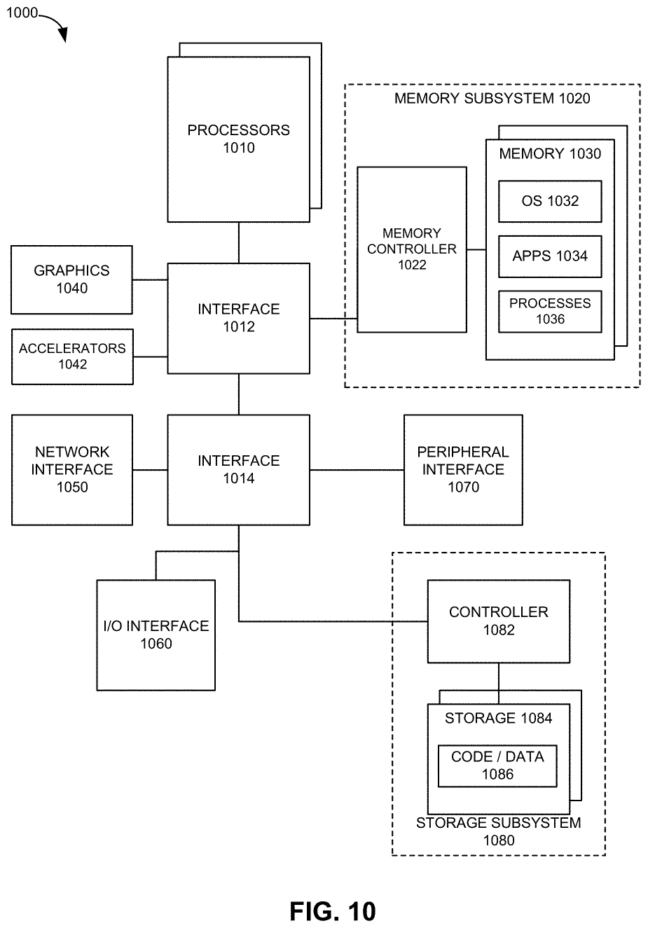

Hardware resources 110-0 can include one or more of: one or more processors; one or more programmable packet processing pipelines; one or more accelerators; one or more hardware queue managers (HQM), one or more application specific integrated circuits (ASICs); one or more field programmable gate arrays (FPGAs); one or more graphics processing units (GPUs); one or more memory devices; one or more storage devices; one or more interconnects; one or more device interfaces; one or more network interface devices; one or more servers; one or more computing platforms; a composite server formed from devices connected by a network, fabric, or interconnect; or other devices. In some examples, a network interface device can refer to one or more of: a network interface controller (NIC), a remote direct memory access (RDMA)-enabled NIC, SmartNIC, router, switch, forwarding element, infrastructure processing unit (IPU), or data processing unit (DPU). For example, a device interface can communicate based on Peripheral Component Interconnect Express (PCIe), Compute Express Link (CXL), Universal Chiplet Interconnect Express (UCIe), or other connection technologies. See, for example, Peripheral Component Interconnect Express (PCIe) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof. See, for example, UCIe 1.0 Specification (2022), as well as earlier versions, later versions, and variations thereof. Various examples of hardware devices are described at least with respect to FIG. 9 or 10. Hardware resources 110-0 can execute system software such as operating system (OS), device driver, and other software described herein.

Process 112-0 can include one or more of: microservice, virtual machine (VMs), container, or other distributed or virtualized execution environments. In some examples, processes 112-0 to 112-N executing on respective nodes 100-0 to 100-N can be associated as a microservice service chain to be executed in a sequence or order and to communicate using a service mesh. For example, process 112-0 executing on node 100-0 can generate data that is to be processed by process 112-1 executed by node 100-1.

Processes 100-0 to 100-N can perform network functions that can include UPF. For example, processes 100-0 to 100-N can perform packet detection or forwarding based on packet detection rules (PDR) or forwarding action rules (FAR). Processes 100-0 to 100-N can perform one or more of: Access Control List (ACL), GTP-U tunnel encapsulation, decapsulation, bearer lookup, Service data flow (SDF) mapping, Per-flow QoS (e.g., QCI performance characteristics), Guaranteed bit rate (GBR), Maximum bit rate (MBR), APN level aggregate Maximum Bit Rate (APN-AMBR), charging (online/offline charging, enforcement of charging policies), or forwarding of packets to/from packet data network.

As described herein, orchestration 118 can selectively adjust a node that executes a process based on received telemetry data 116-0 indicative of operations of processes 112-0 to 112-N and at least one service level agreement (SLA) parameter associated with operations of processes 112-0 to 112-N. For example, orchestration 118 can selectively adjust communications boundaries between processes such as one or more of: chip-to-chip communications, die-to-die communications, packet-based communications, communications over a device interface, fabric-based communications, and so forth. Telemetry data 116-0 can include one or more of: aggregate network throughput, per-flow network throughput, per-flow latency, per-flow jitter, per-flow packet loss, platform CPU utilization, platform memory and I/O bandwidth utilization, and others. SLA parameters applicable to processes can include one or more of: time to complete a process and provide a data output, latency, jitter, memory allocation, memory bandwidth, I/O bandwidth, processor or compute allocation, and others.

Orchestration 118 can be executed on node 100-0 or among multiple of nodes 100-0 to 100-N. Orchestration 118 can manage break-in/break-out (BIBO) interface locations or communication interface locations by adjusting a platform or device execution of processes. BIBO interface boundaries can include physical and/or logical input and output interfaces across communications boundaries, allowing quality of service (QoS) and traffic management at boundaries.

Orchestration 118 can break a monolithic image into two or more microservices that are runtime sub-images, but without the need to reload the image. Within the monolithic image, at every microservice-to-microservice (or subimage-to-subimage) boundary, it is possible to orchestrate break-out (or break-in) microservices/sub-images at increasing (decreasing) granularity. Dynamic orchestration of those BIBO interfaces differs from a monolithic deployment and may provide improved tolerance against FAFO events and reduce the impact to performance or latency. BIBO interface boundaries can have many logical input and output interfaces, allowing quality of service (QoS) and traffic management at boundaries. QoS and traffic management can utilize acceleration (e.g., HQM, CXL, low latency memory, etc.). Note that sub-image and microservice are used interchangeably.

Implementations of 1:1, 1+1, 1:N resiliency techniques may replicate the entire system including switches, routers, load balancer, and so forth, which can incur cost, physical space, and energy and heat dissipation. By dynamic orchestration of BIBO interfaces, a network or information technology (IT) administrator can select a granularity of resource or service redundancy to achieve desired resiliency goals with fine-grained control.

Orchestration 118 can cause storage of Reliability Checkpoint Logging (RCL) 114. RCL 114 can represent a code-path among network functions and data-state check points. For example, RCL 114 can represent a topology of a chain or sequence of executed processes 112-0 to 112-N and data dependencies among processes whereby data generated by a process is available for processing by at least one other process. The topology of a chain or sequence of executed processes can identify devices that execute processes. A data structure of RCL 114 can include one or more of: microservice identifiers, microservice execution order, device Internet Protocol (IP) or Media Access Control (MAC) address, and so forth.

Data-state checkpoints can include transaction check points that record pre-transformation state of data followed by the post transformation state of data. A workload of processes can be associated with code-path check points that can be compared to RCL 114. To recover from disruption to normal completion of a group of micro-services, the checkpoint log or combination of checkpoint logs can be accessed to access generated data by one or more processes in a sequence of processes. Orchestration 118 can access a checkpoint log or combination of checkpoint logs to recover from disruption of one or more of processes 112-0 to 112-N to provide for continued execution of the disrupted process by accessing data that has been generated and is available to access by reusing such generated data and re-starting a process or processes that access generated data to continue a sequence of execution of processes. Orchestration 118 can relaunch operations of one or more processes 112-0 to 112-N after a fault to attempt to complete a workload generated by completion of processes 112-0 to 112-N. If a fault occurs, either the post-transformation data state is omitted, or the post transformation data state has not been acknowledged as correct following 2-phase commit or other consistency protocols.

Data-state checkpoints can be hosted by endpoint hosting network functions, data brokers, and/or data brokers hosted by shared infrastructure, such as programmable network switches and/or network interface devices. Data brokers could securely expose such data as generally addressable memory, semaphores, RCL datastores and other data constructs, as well as track network functions with access to such data. A deployment may include multiple data brokers, and mapping between data brokers and their hosting of a particular data sets may be requested by processes or assigned by management and control layers.

For example, a network or information technology (IT) administrator can select a granularity of resource or service redundancy to provide higher resiliency for a strict subset of processes deemed critical to provide resiliency of a network function or sequence of processes.

In some examples, a node or network interface device can execute a redundant or duplicate instance of a particular process for access in case another instance of such process becomes unavailable. The network interface device can be programmed via control-plane and dynamically activated with data-plane programming, as described herein. Processes can be classified by level of priority and processes with a priority level at or above a threshold level can receive resiliency protection, whereas processes with a priority level below the threshold level may not receive resiliency protection from orchestration 118, a controller, or resiliency control network (RCN).

As described herein, one or more of nodes 100-0 to 100-N can be part of an International Mobile Telecommunications (IMT) network (e.g., a cellular network) communicatively coupled to a resiliency control network (RCN), sometimes called a Resilient & Intelligent NextG Systems (RINGS) control network. In some examples, orchestration 118 on node 100-0 and one or more other of nodes 100-0 to 100-N can perform operations of an RCN. The RCN can be implemented using networked-connected nodes, such as a controller, diagnostic device, and the repair and recovery device, to support correction of the IMT network into a recovered version of the IMT network. In some examples, an RCN maintains a recent of RCL logs to reconstruct data generated by the workload, and can repair or reinstall software or firmware to continue operation of a sequence of processes. RCN can access check-point logs to relaunch processes from after their start by accessing generated data.

FIG. 1B depicts an example system. IMT nodes 150-0 to 150-P can be implemented as a computing platform with communications capabilities such as node 100-0. In some examples, P is an integer and is 3 or more. One or more of IMT nodes 150-0 to 150-P can perform operations of an RCN, as described herein. A workload can be composed of one or more processes (e.g., microservices). A workload may include a sequence of operations that may utilize one or more operating system (OS) processes. For example, IMT node 150-0 can utilize RCN circuitry 150-1 to reconstruct data generated by the workload, and can cause execution of workload on particular platform(s) to continue operation of a sequence of processes of the workload. Should a FAFO event or other failure or degradation of performance occur at one or more IMT nodes, RCN 152-1 can cause resumption of operations of the processes by changing hardware resources allocated to perform processes, access previously generated data so that the chain of processes can restart at a failed process in the chain instead of earlier or at a beginning process of a chain, and reconstruct a microservice mesh (service mesh) to provide communications among multiple workload processes. A service mesh can provide service-to-service communications between microservices using application programming interfaces (APIs). A service mesh can be implemented using a proxy instance (e.g., sidecar) to manage service-to-service communications. Some network protocols used by microservice communications include Layer 7 protocols, such as Hypertext Transfer Protocol (HTTP), HTTP/2, remote procedure call (RPC), gRPC, Kafka, MongoDB wire protocol, and so forth. Envoy Proxy is a well-known data plane for a service mesh. Istio, AppMesh, and Open Service Mesh (OSM) are examples of control planes for a service mesh data plane.

RCN 152-1 can access RCL logs 154-1 to determine data previously generated by a process in a sequence of processes to reuse previously generated data so that the processing does not need to be performed again. RCN 152-1 can access RCL logs 154-1 to determine platforms that execute a failed process or process with degraded performance (e.g., unresponsive to communications) to determine to change an IMT node that executes the failed process or process with degraded performance so that a different IMT node executes the process, repair or reinstall the process on a same or different IMT node, and other reconstruction tasks. The RCN can also include a mesh network executed on two or more of IMT nodes 150-0 to 150-P so that if one of IMT nodes fails or a communication channel with such IMT node fails, another IMT node is able to execute an RCN. While examples are described with respect to IMT nodes, other nodes can be used, such as a computing platform node with hardware resources such as described with respect to FIG. 1A.

FIG. 1C depicts an example operation of an RCN. In some examples, an IMT network 170 (e.g., a cellular network) is communicatively coupled to a RCN 175, sometimes called a RINGS control network. RCN 175 can include networking nodes, such as the illustrated controller 180, diagnostic device 185, and the repair and recovery device 190. One or more of these devices can be implemented in computer hardware to support the correction of the IMT 170 into a recovered version of the IMT 195. In some examples, the RCN 175 is a single node that includes each of the illustrated elements. In some examples, the elements may be implemented in processing circuitry of the node.

RCN 175 can be configured to manage allocation of processes for execution on hardware devices and to manage boundary interfaces among processes. RCN 175 can be configured to manage or control data plane layers of the IMT 170 through a dedicated and isolated control plane that executes layer-specific management functions, such as Communications Service Management Functions (CSMF), Network Slice Management Functions (NSMF), or Resource Management Functions (RMF). RCN nodes, including the RCN 175, may configure sentinels to detect FAFO events, or configure controllers to execute resiliency functions designed to repair and recover data plane resources, slices, or services. In some examples, RCN 175 can react to FAFO events using proactive resiliency-by-design techniques.

The following examples of the RCN implementation refer to the processing circuitry resident within RCN 175, whether within a single node or spread across several nodes. To implement network slice resiliency, the processing circuitry can be configured to obtain (e.g., via controller 180) an indication of a FAFO event for a network slice. A network slice can include one of multiple network functions in operation in the IMT 170. The indication of the FAFO event may be a warning transmitted from another RCN, a monitoring device of the IMT 170, or a node of the IMT 170 that detects the problem. In some examples, the indication of the FAFO event may be determined by RCN 175 via the diagnostic device 185 (or service) hosted by the RCN 175. The indication can provide evidence sufficient for the RCN 175 to act. For example, an SLA threshold has been violated at a rate beyond defined operating tolerances.

The processing circuitry can be configured to estimate capacity in a slice segment to meet service level agreement (SLA) parameters of one or more network slices based on the FAFO event. A slice segment can include a set of physical resources shared by the multiple network slices. For example, a radio slice segment may include frequencies or codes that are logically divided among slices. Other slice segments may include hardware at a base station or in the core network of the IMT 170. Estimating the slice segment capacity can include determining whether, for example, enough available processing at a base station is available to process traffic, such as retransmission traffic or excess traffic in a denial of service attack, of the slices that use the slice segment. In general, the traffic or computing (e.g., to remove virus signatures) levels determined to be needed to address the impact of the FAFO event are estimated. The expected resources can be compared with the capacity of the slice segment, with respect to the affected slice or the slice segment as a whole. If the comparison demonstrates that the slice segment includes sufficient capacity, then the slice segment meets the SLA based on the predicated or actual FAFO event impact; otherwise, it does not.

Slices can be logically isolated from other slices, using techniques such as hardware partitioning, virtualization, etc. It may be the case that the hardware allocated to the FAFO event affected slice is not capable of meeting the SLA for that slice, but other hardware within a slice segment is available. That is, hardware in the slice segment may be unallocated or allocated to another slice that does not need the hardware to meet the SLA for that second slice. Accordingly, in some examples, hardware allocated to a second network slice can be estimated by the processing circuitry to be unnecessary for the second network slice to meet an SLA defined for the second network slice. As noted below, these available resources may be used to address the impact of the FAFO event on the network slice.

In some examples, estimating the capacity indicates that SLAs of the multiple network slices cannot be met (e.g., where a full recovery from the FAFO is not possible). There may be insufficient resources in a slice segment to address the impact of the FAFO event while meeting the SLAs of each of the network slices operating from the slice segment. As noted below, in this case, other techniques are employed to mitigate the effects (e.g., to affect a partial recovery) of the FAFO event. The RCN may apply a graceful degradation strategy when degradation of service is determined to be happening. For example, given two SLAs assigning the same level of workload priority, a round-robin resource allocation strategy may be used to evenly divide resources between the two workloads. Alternatively, resources may be allocated to the first workload to run in a shortened time slice after which the resources are assigned to the second workload for a shortened time slice and so forth. In some examples, SLAs may require workloads to specify a minimum viable resource allocation (MVRA) that determines a threshold resource utilization governing a switch from a resource minimization strategy to a time slice minimization strategy.

In some examples, the processing circuitry can be configured to determine hardware necessary for a given slice to meet the SLA of that slice. For example, the processing circuitry may maintain a set of hardware profiles for the network slice. In some examples, a member of the set of hardware profiles indicates a combination of hardware evaluated to meet an SLA for the network slice. This database of hardware profiles may be predefined or created by observing operations on the network slice. For example, the processing circuitry may be configured to monitor resource use by the slice at the slice segment during normal use, or a normal operation period. Here, the normal operation period is defined, such as through a statistical relevance with respect to other operational periods, or through predefined network tolerances. In some examples, the normal operation period is a period of time in which no FAFO event is indicated.

To build the set of hardware profiles, the processing circuitry is configured to monitor (e.g., via the diagnostic device 185) the hardware components, and even allocate different hardware components, to the slice to determine impacts various hardware components have on slice performance. Combinations of hardware components, such as accelerators, processors, storage devices, etc., may be written as a member of the set of hardware profiles. In some examples, performance of the hardware component combination can be evaluated against a predefined performance threshold to determine whether to write the combination into the set of hardware profiles. Thus, if a particular combination did not satisfy the SLA under normal operating conditions, that combination is omitted from the set of hardware profiles.

The processing circuitry can be configured to modify operation of the slice segment, using repair and recovery device 190 to access a dedicated and isolated control plane, on results from estimating the capacity in the slice segment. Thus, the processing circuitry can respond to the FAFO event impact by, for example, allocating more hardware or adjusting network traffic. In the example provided above where the second slice was allocated excessive hardware to meet the SLA of the second slice, the processing circuitry can be configured to allocate the hardware reserved for the second network slice to the network slice experiencing the FAFO event. In an example, the slice segment may include unallocated (e.g., reserve) hardware that is not allocated to any given slice under normal operation. Here, the slice segment may be modified by allocating some or all of such unallocated hardware to the slice segment. In an example, the reserve hardware allocation is temporary. In some examples, the reserve hardware is unallocated upon a trigger condition, such as the passing of the FAFO event, a predefined timer period, or upon the implementation of another modification to the slice segment. Thus, for example, the reserve hardware may fill a time gap between needed to deallocate the hardware from the second slice and reallocate that hardware to the slice.

In some examples, when the capacity estimation above indicates that SLAs of the multiple network slices cannot be met, the processing circuitry can be configured to modify the operation of the slice segment by requesting an admission controller to reduce traffic injection based on priority. The admission controller can be a switch or gateway accepting data (e.g., packets) at the slice segment. The admission controller may be instructed to turn away (e.g., drop) packets with a low priority, delay (e.g., buffer) packets with a middle priority, and pass through packets with a high priority. The network infrastructure can be leveraged to reduce data flow such that the available hardware at the slice segment may handle the data flow. By basing the reduction on priority, the most important SLAs are more likely to be met, leaving lower priority SLA to bear the majority of the FAFO event impacts.

In some examples, where the capacity estimation above indicates that SLAs of the multiple network slices cannot be met, operation of the slice segment may be modified to buffer latency tolerant traffic during the FAFO event. Traffic that is non latency sensitive can be stored to reduce the rate at which it needs to be processed. This may provide time to allocate additional hardware resources to the slice. In some examples, latency tolerant traffic may be identified by a flag within the traffic, the SLA under which the traffic operates, or by correlating identifying features of the traffic with a database of latency tolerant traffic, for example.

In some examples, where the capacity estimation above indicates that SLAs of the multiple network slices cannot be met, operation of the slice segment may be modified to direct a sender of the traffic to use a second network slice from the multiple network slices. Here, there is an attempt to isolate the FAFO event to the slice and notify the entities (e.g., software or hardware) using the slice that another slice should be used. In order to control the impact redirecting the traffic will have on the other slices, and thus the SLAs of those other slices, the processing circuitry can be configured to specify which second slice should be used for the traffic.

In some examples, the processing circuitry is configured to monitor operation of the network slice over a sliding time period to produce a slice-segment-resource-busy-ratio (SSR-BR) for a hardware resource (e.g., component) of the slice segment. The sliding window ensures that the SSR-BR is presently relevant and not influence by long passed events. The SSR-BR is hardware resource (e.g., memory, an accelerator, etc.) specific but applies across all slices. Thus, the SSR-BR measures how busy the hardware resource is within the present time period regardless of which slice is using the hardware resource.

In some examples, the processing circuitry can be configured to produce a slice-segment-resource occupancy-ratio (SSR-OR) for the hardware resource. The SSR-OR is slice, or application, specific as opposed to the SSR-BR. Thus, the SSR-OR enables one to determine what impact a specific application or slice has with respect to the hardware resource. In some examples, if the SSR-BR is determined by the processing circuitry to be beyond a threshold, the indication of the FAFO event may be created by the processing circuitry in response. This last example illustrates FAFO event detection, or prediction, by the RCN 175. A rise in the SSR-BR beyond the threshold indicates that the overall utilization of the hardware resources is unexpected, abnormal, or extraordinary and indicative of a FAFO event.

In some examples, when the SSR-OR is determined to be beyond a threshold (e.g., an SSR-OR threshold), the processing circuitry can be configured to limit access to the hardware resource, by the application or the slice. In some examples, limiting access means preventing access. In some examples, the access limitation persists until the SSR-OR meets (e.g., is equal to or less than) the threshold. In some examples, limiting access include buffering latency tolerant traffic for a predefined period of time. In some examples, the threshold is based on a priority of an application generating the SSR-OR. By observing hardware resource utilization by the application, an uptick in SSR-OR—for example, without a corresponding increase in SSR-BR—may indicate that the application or the slice are exhibiting atypical behavior indicative of a FAFO event.

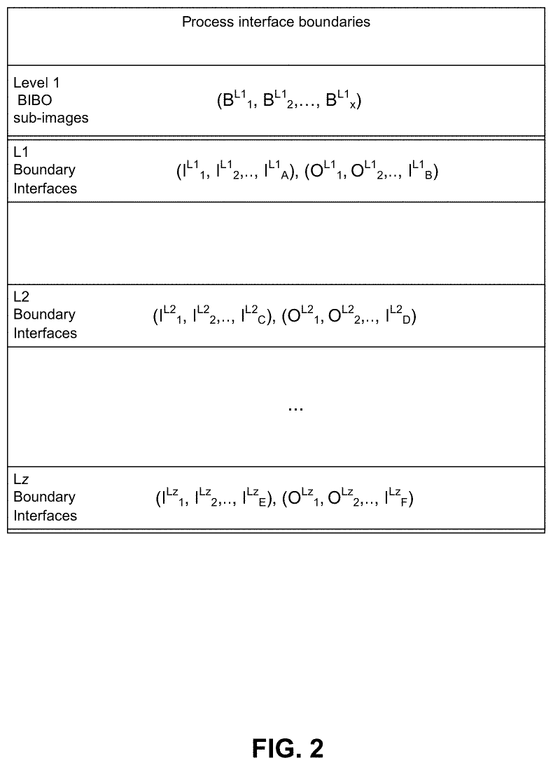

FIG. 2 depicts an example of communication interface boundaries between processes. The levels 1 to z represent different compositions of processes with different interface boundaries, where z is an integer that is 3 or more. For example, level 1 BIBO sub-images (B^{L1}₁, B^{L1}₂, . . . , B^{L1}ₓ) can be decomposed into Level 1 (L1), Level 2 (L2), or Level z (Lz) compositions of processes with different interface boundaries. L1 composition can be defined by (i) processes (I^{L1}₁, I^{L1}₂, . . . , I^{L1}_{A}) executed on a node or group of nodes such as one or more servers, server, rack, or datacenter rack, or server, rack, or datacenters and (ii) interfaces to processes (O^{L1}₁, O^{L1}₂, . . . , I^{L1}_{B}). L2 composition can be defined by interfaces to processes (I^{L2}₁, I^{L2}₂, . . . , I^{L2}_{C}) and (O^{L2}₁, O^{L2}₂, . . . , I^{L2}_{D}). L3 composition can be defined by interfaces to processes (I^{Lz}₁, I^{Lz}₂, . . . , I^{Lz}_{E}) and (O^{Lz}₁, O^{Lz}₂, . . . , I^{Lz}_{F}). An interface can provide process-to-process communications. Based on telemetry data and applicable SLA parameters for a workload of one or more processes, an orchestrator or RCN can adjust interface boundaries and update an RCL to identify the topology.

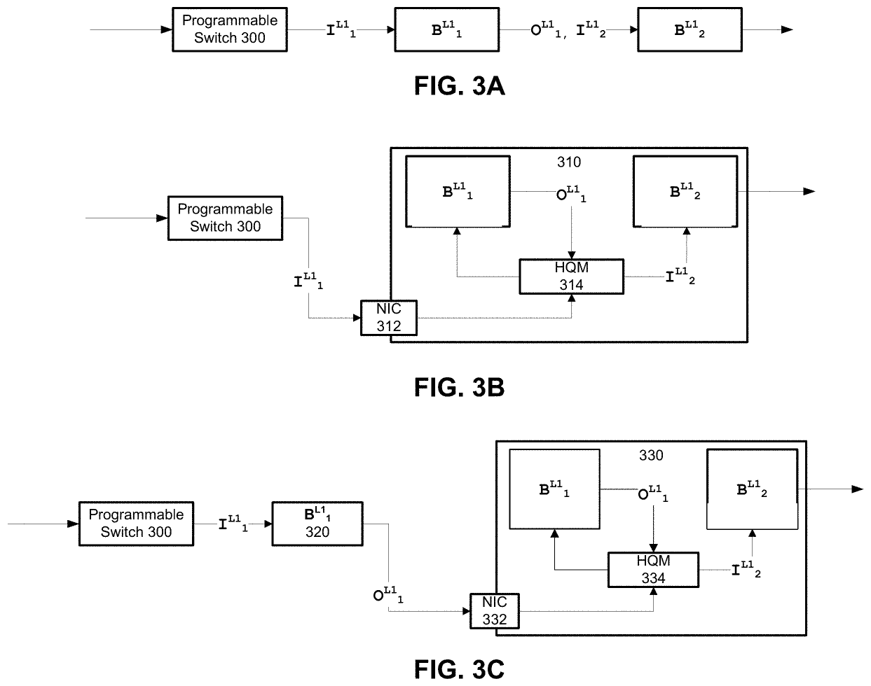

FIGS. 3A-3C depicts an example of modification of an interface boundary. FIG. 3A depicts a chain of processes of a network function deployed and running as separate processes B^{L1}₁ and B^{L1}₂ executed by two different servers and communication to B^{L1}₁ can occur via interface I^{L1}₁ whereas communication to B^{L1}₂ can occur via interface O^{L1}₁ I^{L1}₁. The input packets to process B^{L1}₁ can be provided by a programmable switch 300, but can be provided by other network interface devices as well. In some examples, programmable switch 300 can detect if a network function is functioning properly based on a health report of telemetry data, as described herein. The health report of telemetry data can indicate a latency of communications between servers that execute B^{L1}₁ and B^{L1}₂. In this example, the latency of communications exceeds a threshold level, I^{L1}₁ or B^{L1}₁ fail, or telemetry data indicates a likely failure of I^{L1}₁ or B^{L1}₂, and programmable switch 300 causes a change in devices that execute B^{L1}₁ and B^{L1}₂. Programmable switch 300 can select another deployment configuration to execute B^{L1}₁ and B^{L1}₂ based on telemetry data indicating that second computing platform is capable to perform B^{L1}₁ and B^{L1}₂ in conformance with SLA applicable to B^{L1}₁ and B^{L1}₂. Example deployment configurations are described with respect to FIGS. 3B and 3C.

FIG. 3B depicts example executions of B^{L1}₁ and B^{L1}₂ on platform 310. Switch 300 can cause B^{L1}₁ and B^{L1}₂ to be executed on platform 310. Platform 310 can include and utilize hardware and software components described with respect to node 100-0. As in the deployment in FIG. 3A, a communication to B^{L1}₁ can occur via interface I^{L1}₁ whereas communication to B^{L1}₂ can occur via interface O^{L1}₁ I^{L1}₁, however, interface I^{L1}₁ can provide communications from switch 300 to NIC 312. In some examples, a hardware queue manager (HQM) can provide communications for interface O^{L1}₁ I^{L1}₁ between processes B^{L1}₁ and B^{L1}₂. For example, CPU cores executing processes can be mapped to HQM queues.

FIG. 3C depicts another example deployment that could be selected after the deployment in FIG. 3A. For example, switch 300 can cause B^{L1}₁ to be executed on platforms 320 and 330 and B^{L1}₂ to be executed on platform 330. Platforms 320 and 330 can include and utilize hardware and software components described with respect to node 100-0. In this deployment, B^{L1}₁ is executed in a redundant and resilient manner by executing on platforms 320 and 330 so that if operation of B^{L1}₁ on platform 320 fails to meet applicable SLAs or telemetry indicates that there is likely failure of SLA, output from B^{L1}₂ executing on platform 330 can be accessed. Conversely, if operation of B^{L1}₂ on platform 330 fails to meet applicable SLAs or telemetry indicates that there is likely failure of SLA, output from B^{L1}₁ executing on platform 320 can be accessed. The configuration of B^{L1}₁ and B^{L1}₂ executing on platform 330 can be similar to that of platform 310.

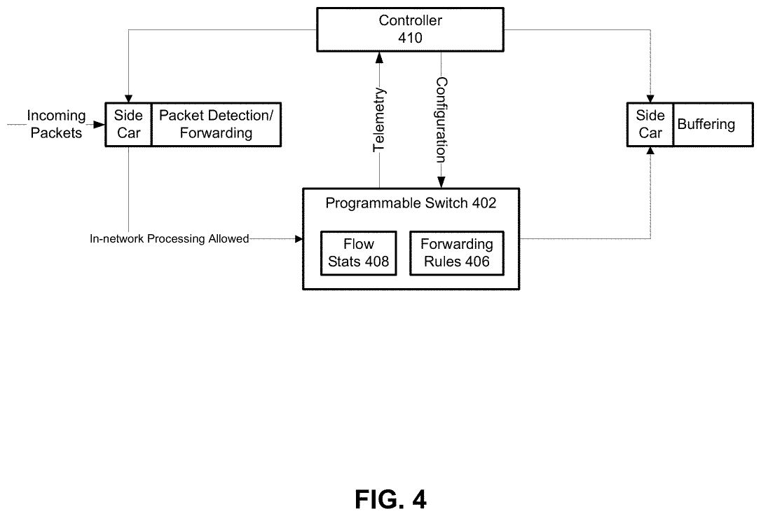

FIG. 4 depicts an example use of network interface device to manage interface boundaries between network functions or processes. Based on collected telemetry data (e.g., completed process-to-process communications), if controller 410 detects that the packet forwarding deployed on a server is not performing according to applicable SLA parameters (e.g., number of process-to-process communications completed being less than a threshold, number of process-to-process communications decreasing over time, etc.), controller 410 may transition management of process-to-process communications from a server or another programmable switch to programmable switch 402. In addition, controller 410 can adjust a process-to-process boundary by changing or adjusting a hardware resource that performs a process or direct communications to a hardware that executes a redundant process. Controller 410 can implement an RCN, in some examples.

For example, programmable switch 402 can include circuitry that can be configured to perform match-action operations using one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others. In some examples, programmable switch 402 can execute a service mesh side car to apply forwarding rules 406 for communications among processes. Controller 410 can configure programmable switch 402 with match-action rules to forward particular packets to processes that have been changed to be executed by different hardware resources. For example, match-action rules can cause forwarding of packets with particular tags to the adjusted or updated hardware resources. States of high priority flows (e.g., 3GPP release 15 5G ultra-reliable low latency communications (URLLC) flows) can be kept in on-chip memory as flow statistics 408 in programmable switch 402.

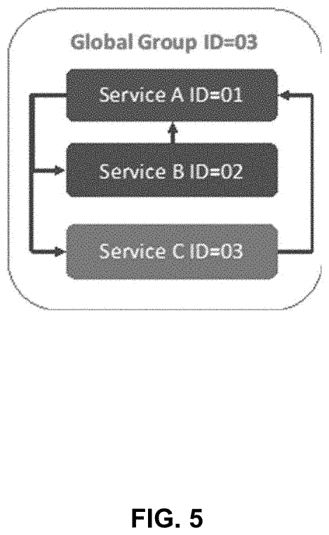

FIG. 5 depicts an example of associating telemetry with processes. Processes (e.g., microservices) can be associated with a global group identifier (ID) so that telemetry associated with such processes can be utilized to determine whether to adjust a process-to-process boundary. Scale-out tracing circuitry can track telemetry for a workload or group of processes, such as network functions composed of multiple micro-services and/or services that process traffic after completion of network functions, such as UPF. Network functions and processes can be associated with a Group ID. For instance, group identifier (GID) 0x03 may be associated with three services with different data flows (e.g., Service C sends inputs to A, then A sends to B, then B sends inputs to C). GID of 0x03 can be used to identify telemetry associated with services A-C.

Nodes and network interface devices can track packets and process-to-process communications associated with a particular GID. Data packets in the network may be tagged with the GID. A GID can be registered with monitoring circuitry in nodes and network interface devices to stores the telemetry associated with the GID. Microservice process address space identifier (IDs) (PASIDs) running inside the CPU can be mapped to the GID. Nodes and/or network interface devices may collect operation metrics for processors executing processes associated with a PASID and store the metrics into memory or pooled memory for the corresponding GIDs for access by a controller, orchestrator, or RCN. Network interface controllers (NICs) and switches can report telemetry for GIDs.

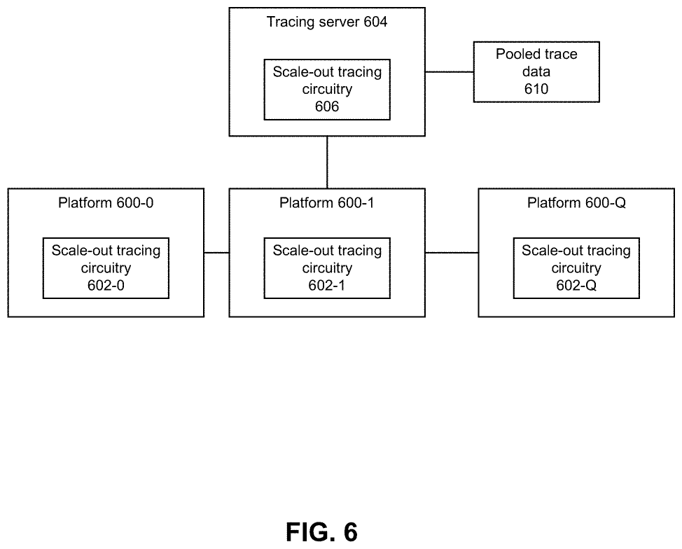

FIG. 6 depicts an example system to trace telemetry data associated with process-to-process communications. Platforms 600-0 to 600-Q (where Q is an integer of 2 or more) can include respective scale-out tracing circuitries 602-0 to 602-Q. Scale-out tracing circuitries 602-0 to 602-Q can determine telemetry associated with one or more GID and store the telemetry in memory or provide the telemetry to tracing server 604 for storage in pooled trace data in pooled memory 610. Telemetry can be used to identify performance bottlenecks in different parts of a data center. Based on predicted failures or performance degradation, service migration can be performed to migrate processes to execute on different hardware resources and change interface boundaries to reduce latency of workload completion.

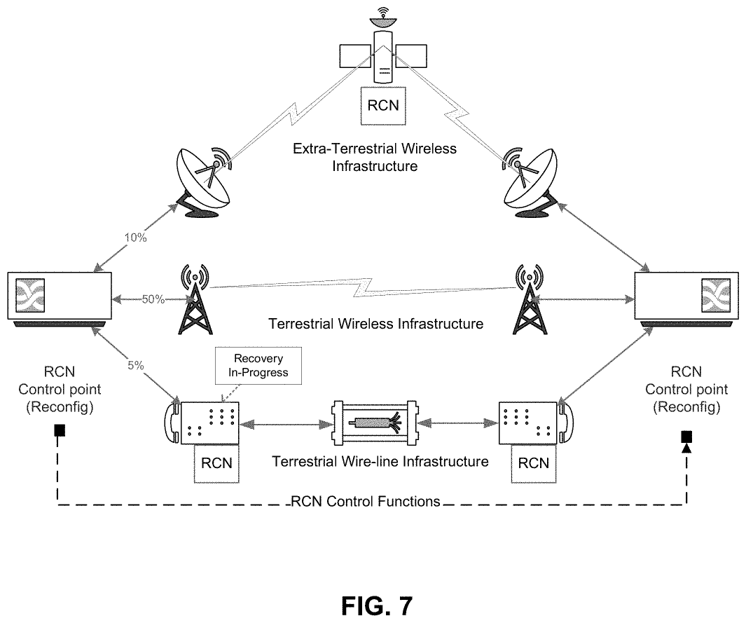

FIG. 7 depicts an example system. RCN nodes may communicate over available channels, even at limited bandwidth capacity such as 10%, 5%, or 50%, to improve reliability of operations of processes. Multiple RCN nodes may communicate as a mesh to route packets to the RCN control point that can respond to a FAFO event or potential FAFO event. For example, the RCN node that executes on a same platform as that of a process may be selected to recover the process, in the event of process failure, and restore state of the process to continue operation on a same or different platform.

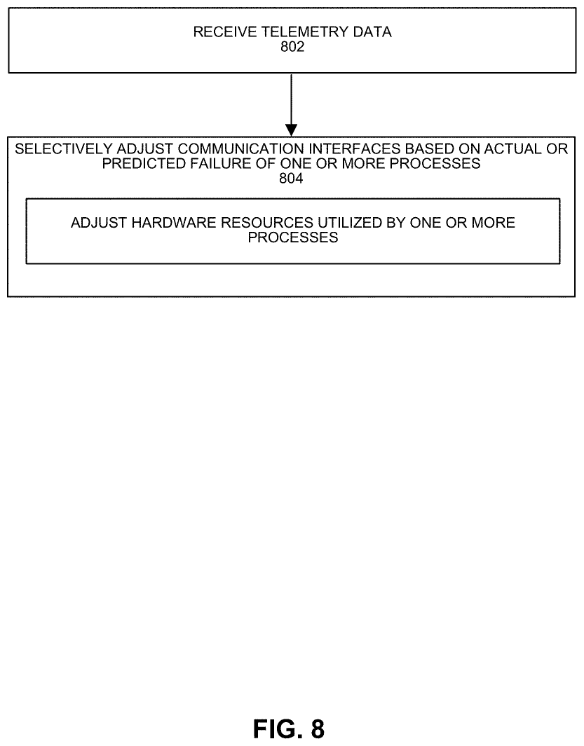

FIG. 8 depicts an example process. The process can be performed by a controller, scheduler, orchestrator, RCN, or hypervisor, in some examples. At 802, telemetry data indicating utilization of one or more hardware resources and network communications can be stored. The one or more hardware resources can be used to execute processes and network communications can provide communications among processes. At 804, based on identification of an anticipated or actual failure of operation of a process, one or more communication interfaces between processes can be adjusted. For example, failure of operation of a process can be determined based on failure to meet an SLA associated with the process such as time to completion. For example, a trained ML model can identify anticipated failure of operation of a process. Adjustment of one or more communication interfaces between processes can cause a change of a hardware resources that executes one or more processes to hardware resources that is expected to execute the processes and satisfy SLA parameters. In some examples, a path of communication through one or more switches can be adjusted between hardware resources to reduce latency of communication.

FIG. 9 depicts an example network interface device. In this system, network interface device 900 manages performance of one or more processes using one or more of processors 906, processors 910, accelerators 920, memory pool 930, or servers 940-0 to 940-N, where N is an integer of 1 or more. In some examples, processors 906 of network interface device 900 can execute one or more processes, applications, VMs, microVMs, containers, microservices, and so forth that request performance of workloads by one or more of: processors 910, accelerators 920, memory pool 930, and/or servers 940-0 to 940-N. Network interface device 900 can utilize network interface 902 or one or more device interfaces to communicate with processors 910, accelerators 920, memory pool 930, and/or servers 940-0 to 940-N.

Network interface device 900 can utilize programmable pipeline 904 to process packets that are to be transmitted from network interface 902 or packets received from network interface 902. Programmable pipeline 904, processors 906, accelerators 920 can include a programmable processing pipeline or offload circuitries that is programmable by Programming Protocol-independent Packet Processors (P4), SONiC, Broadcom® Network Programming Language (NPL), NVIDIA® CUDA®, NVIDIA® DOCA™, Infrastructure Programmer Development Kit (IPDK), x86 compatible executable binaries or other executable binaries. A programmable processing pipeline can include one or more match-action units (MAUs) that are configured based on a programmable pipeline language instruction set. Processors, FPGAs, other specialized processors, controllers, devices, and/or circuits can be used utilized for packet processing or packet modification. Ternary content-addressable memory (TCAM) can be used for parallel match-action or look-up operations on packet header content. As described herein, programmable pipeline 904 and/or processors 906 can manage process-to-process communication interfaces.

FIG. 10 depicts an example computing system. Operations and connections of components and sub-components of system 1000 (e.g., processor 1010, memory controller 1022, graphics 1040, accelerators 1042, network interface 1050, controller 1082, and so forth) can be configured to manage process-to-process communication interfaces, as described herein. System 1000 includes processor 1010, which provides processing, operation management, and execution of instructions for system 1000. Processor 1010 can include any type of microprocessor, central processing unit (CPU), graphics processing unit (GPU), processing core, or other processing hardware to provide processing for system 1000, or a combination of processors. Processor 1010 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1000 includes interface 1012 coupled to processor 1010, which can represent a higher speed interface or a high throughput interface for system components that needs higher bandwidth connections, such as memory subsystem 1020 or graphics interface components 1040, or accelerators 1042. Interface 1012 represents an interface circuit, which can be a standalone component or integrated onto a processor die. Where present, graphics interface 1040 interfaces to graphics components for providing a visual display to a user of system 1000. In one example, graphics interface 1040 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 1040 generates a display based on data stored in memory 1030 or based on operations executed by processor 1010 or both. In one example, graphics interface 1040 generates a display based on data stored in memory 1030 or based on operations executed by processor 1010 or both.

Accelerators 1042 can be a fixed function or programmable offload engine that can be accessed or used by a processor 1010. For example, an accelerator among accelerators 1042 can provide compression (DC) capability, cryptography services such as public key encryption (PKE), cipher, hash/authentication capabilities, decryption, or other capabilities or services. In some embodiments, in addition or alternatively, an accelerator among accelerators 1042 provides field select controller capabilities as described herein. In some cases, accelerators 1042 can be integrated into a CPU socket (e.g., a connector to a motherboard or circuit board that includes a CPU and provides an electrical interface with the CPU). For example, accelerators 1042 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 1042 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 1020 represents the main memory of system 1000 and provides storage for code to be executed by processor 1010, or data values to be used in executing a routine. Memory subsystem 1020 can include one or more memory devices 1030 such as read-only memory (ROM), flash memory, one or more varieties of random access memory (RAM) such as DRAM, or other memory devices, or a combination of such devices. Memory 1030 stores and hosts, among other things, operating system (OS) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software logic to provide functions for system 1000. In one example, memory subsystem 1020 includes memory controller 1022, which is a memory controller to generate and issue commands to memory 1030. It will be understood that memory controller 1022 could be a physical part of processor 1010 or a physical part of interface 1012. For example, memory controller 1022 can be an integrated memory controller, integrated onto a circuit with processor 1010.

In some examples, OS 1032 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, Broadcom®, Nvidia®, IBM®, Texas Instruments®, among others.

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1000 includes interface 1014, which can be coupled to interface 1012. In one example, interface 1014 represents an interface circuit, which can include standalone components and integrated circuitry. In one example, multiple user interface components or peripheral components, or both, couple to interface 1014. Network interface 1050 provides system 1000 the ability to communicate with remote devices (e.g., servers or other computing devices) over one or more networks. Network interface 1050 can include an Ethernet adapter, wireless interconnection components, cellular network interconnection components, USB (universal serial bus), or other wired or wireless standards-based or proprietary interfaces. Network interface 1050 can transmit data to a device that is in the same data center or rack or a remote device, which can include sending data stored in memory. Network interface 1050 (e.g., packet processing device) can execute a virtual switch to provide virtual machine-to-virtual machine communications for virtual machines (or other virtual environments) in a same server or among different servers. Operations and connections of network interface 1050 with offload circuitry (e.g., processors 1010, accelerators 1042, and others) can be configured by an instruction set based on a programmable pipeline language, as described herein.

Some examples of network interface 1050 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 1000 includes one or more input/output (I/O) interface(s) 1060. I/O interface 1060 can include one or more interface components through which a user interacts with system 1000 (e.g., audio, alphanumeric, tactile/touch, or other interfacing). Peripheral interface 1070 can include any hardware interface not specifically mentioned above. Peripherals refer generally to devices that connect dependently to system 1000. A dependent connection is one where system 1000 provides the software platform or hardware platform or both on which operation executes, and with which a user interacts.

In one example, system 1000 includes storage subsystem 1080 to store data in a nonvolatile manner. In one example, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, or optical based disks, or a combination. Storage 1084 holds code or instructions and data 1086 in a persistent state (e.g., the value is retained despite interruption of power to system 1000). Storage 1084 can be generically considered to be a “memory,” although memory 1030 is typically the executing or operating memory to provide instructions to processor 1010. Whereas storage 1084 is nonvolatile, memory 1030 can include volatile memory (e.g., the value or state of the data is indeterminate if power is interrupted to system 1000). In one example, storage subsystem 1080 includes controller 1082 to interface with storage 1084. In one example controller 1082 is a physical part of interface 1014 or processor 1010 or can include circuits or logic in both processor 1010 and interface 1014.

A volatile memory is memory whose state (and therefore the data stored in it) is indeterminate if power is interrupted to the device. Dynamic volatile memory requires refreshing the data stored in the device to maintain state. One example of dynamic volatile memory incudes DRAM (Dynamic Random Access Memory), or some variant such as Synchronous DRAM (SDRAM). Another example of volatile memory includes cache or static random access memory (SRAM).

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, or NVM devices that use chalcogenide phase change material (for example, chalcogenide glass).

A power source (not depicted) provides power to the components of system 1000. More specifically, power source typically interfaces to one or multiple power supplies in system 1000 to provide power to the components of system 1000. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In some examples, system 1000 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMB A) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as Non-volatile memory express (NVMe) over Fabrics (NVMe-oF) or NVMe.

Communications between devices can take place using a network that provides die-to-die communications; chip-to-chip communications; circuit board-to-circuit board communications; and/or package-to-package communications.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that can be configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premise data centers, off-premise data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Example 1 includes one or more examples, and includes at least one non-transitory computer-readable medium comprising instructions stored thereon, that if executed by one or more processors, cause the one or more processors to: modify at least one connection between microservices based on telemetry data.

Example 2 includes one or more examples, wherein the at least one connection between microservices comprises one or more of: chip-to-chip communications, die-to-die communications, packet-based communications, communications over a device interface, or fabric-based communications.

Example 3 includes one or more examples, wherein the telemetry data comprises one or more of: time-to-completion of a microservice, latency of communications between microservices, capacity of one or more processors, capacity of one or more memory devices, or network bandwidth utilization.

Example 4 includes one or more examples, wherein the modify at least one connection between microservices based on telemetry data is also based at least on at least one service level agreement (SLA) parameter associated with the microservices.

Example 5 includes one or more examples, wherein the modify at least one connection between microservices based on telemetry data comprises modify a hardware resource that is to execute one or more of the microservices.

Example 6 includes one or more examples, and including instructions stored thereon, that if executed by one or more processors, cause the one or more processors to: store check-point log of data generated by a workload and access the check-point log of data for a re-launch of the workload to set a starting point within the workload based on previously computed data.

Example 7 includes one or more examples, and includes instructions stored thereon, that if executed by one or more processors, cause the one or more processors to: cause execution of one or more replica microservices; select at least one of the replica microservices; and modify at least one connection between microservices to provide connection to the selected at least one of the replica microservices.

Example 8 includes one or more examples, and includes instructions stored thereon, that if executed by one or more processors, cause the one or more processors to: execute a resiliency control network (RCN) on multiple platforms to collect the telemetry data and perform the modify at least one connection between microservices based on telemetry data.

Example 9 includes one or more examples, and includes an apparatus comprising: an interface and circuitry communicatively coupled to the interface, wherein the circuitry is to modify at least one connection between microservices based on telemetry data.

Example 10 includes one or more examples, wherein the at least one connection between microservices comprises one or more of: chip-to-chip communications, die-to-die communications, packet-based communications, communications over a device interface, or fabric-based communications.

Example 11 includes one or more examples, wherein the telemetry data comprises one or more of: time-to-completion of a microservice, latency of communications between microservices, capacity of one or more processors, capacity of one or more memory devices, or network bandwidth utilization.

Example 12 includes one or more examples, wherein the modify at least one connection between microservices based on telemetry data is also based at least on at least one service level agreement (SLA) parameter associated with the microservices.

Example 13 includes one or more examples, wherein the modify at least one connection between microservices based on telemetry data comprises modify a hardware resource that is to execute one or more of the microservices.

Example 14 includes one or more examples, wherein the circuitry is to: store check-point log of data generated by a workload and access the check-point log of data for a re-launch of the workload to set a starting point within the workload based on previously computed data.

Example 15 includes one or more examples, wherein the microservices are executed on hardware resources and the hardware resources comprise one or more of: one or more processors; one or more programmable packet processing pipelines; one or more accelerators; one or more hardware queue managers (HQM), one or more application specific integrated circuits (ASICs); one or more field programmable gate arrays (FPGAs); one or more graphics processing units (GPUs); one or more memory devices; one or more storage devices; one or more interconnects; one or more device interfaces; one or more network interface devices; one or more servers; or one or more computing platforms.

Example 16 includes one or more examples, and includes a method comprising: modifying at least one connection between microservices based on telemetry data.

Example 17 includes one or more examples, wherein the at least one connection between microservices comprises one or more of: chip-to-chip communications, die-to-die communications, packet-based communications, communications over a device interface, or fabric-based communications.

Example 18 includes one or more examples, wherein the telemetry data comprises one or more of: time-to-completion of a microservice, latency of communications between microservices, capacity of one or more processors, capacity of one or more memory devices, or network bandwidth utilization.

Example 19 includes one or more examples, wherein the modifying at least one connection between microservices based on telemetry data is also based at least on at least one service level agreement (SLA) parameter associated with the microservices.

Example 20 includes one or more examples, wherein the modifying at least one connection between microservices based on telemetry data comprises modifying a hardware resource that is to execute one or more of the microservices.

Example 21 includes one or more examples, and includes at least one non-transitory computer-readable medium comprising instructions stored thereon, that if executed by one or more processors, cause the one or more processors to: dynamically select composition of an application between monolithic implementation and two or more microservices based on telemetry data.

Example 22 includes one or more examples, and includes at least one non-transitory computer-readable medium of claim 21, comprising instructions stored thereon, that if executed by one or more processors, cause the one or more processors to: based on composition of an application as two or more microservices, adjust at least one connection between microservices based on telemetry data.

Example 23 includes one or more examples, and includes instructions stored thereon, that if executed by one or more processors, cause the one or more processors to: configure a switch to perform forwarding of communications between microservices based on the adjusted at least one connection between microservices.

What is claimed is:

1. At least one non-transitory computer-readable medium comprising instructions stored thereon, that if executed by one or more processors, cause the one or more processors to:
modify at least one connection between microservices based on telemetry data.

2. The at least one non-transitory computer-readable medium of claim 1, wherein the at least one connection between microservices comprises one or more of: chip-to-chip communications, die-to-die communications, packet-based communications, communications over a device interface, or fabric-based communications.

3. The at least one non-transitory computer-readable medium of claim 1, wherein the telemetry data comprises one or more of: time-to-completion of a microservice, latency of communications between microservices, capacity of one or more processors, capacity of one or more memory devices, or network bandwidth utilization.

4. The at least one non-transitory computer-readable medium of claim 1, wherein the modify at least one connection between microservices based on telemetry data is also based at least on at least one service level agreement (SLA) parameter associated with the microservices.

5. The at least one non-transitory computer-readable medium of claim 1, wherein the modify at least one connection between microservices based on telemetry data comprises modify a hardware resource that is to execute one or more of the microservices.

6. The at least one non-transitory computer-readable medium of claim 1, comprising instructions stored thereon, that if executed by one or more processors, cause the one or more processors to:
store check-point log of data generated by a workload and
access the check-point log of data for a re-launch of the workload to set a starting point within the workload based on previously computed data.

7. The at least one non-transitory computer-readable medium of claim 1, comprising instructions stored thereon, that if executed by one or more processors, cause the one or more processors to:
cause execution of one or more replica microservices;
select at least one of the replica microservices; and
modify at least one connection between microservices to provide connection to the selected at least one of the replica microservices.

8. The at least one non-transitory computer-readable medium of claim 1, comprising instructions stored thereon, that if executed by one or more processors, cause the one or more processors to:
execute a resiliency control network (RCN) on multiple platforms to collect the telemetry data and perform the modify at least one connection between microservices based on telemetry data.

9. An apparatus comprising:
an interface and
circuitry communicatively coupled to the interface, wherein the circuitry is to modify at least one connection between microservices based on telemetry data.

10. The apparatus of claim 9, wherein the at least one connection between microservices comprises one or more of: chip-to-chip communications, die-to-die communications, packet-based communications, communications over a device interface, or fabric-based communications.

11. The apparatus of claim 9, wherein the telemetry data comprises one or more of: time-to-completion of a microservice, latency of communications between microservices, capacity of one or more processors, capacity of one or more memory devices, or network bandwidth utilization.

12. The apparatus of claim 9, wherein the modify at least one connection between microservices based on telemetry data is also based at least on at least one service level agreement (SLA) parameter associated with the microservices.

13. The apparatus of claim 9, wherein the modify at least one connection between microservices based on telemetry data comprises modify a hardware resource that is to execute one or more of the microservices.

14. The apparatus of claim 9, wherein the circuitry is to:
store check-point log of data generated by a workload and
access the check-point log of data for a re-launch of the workload to set a starting point within the workload based on previously computed data.

15. The apparatus of claim 9, wherein the microservices are executed on hardware resources and the hardware resources comprise one or more of: one or more processors; one or more programmable packet processing pipelines; one or more accelerators; one or more hardware queue managers (HQM), one or more application specific integrated circuits (ASICs); one or more field programmable gate arrays (FPGAs); one or more graphics processing units (GPUs); one or more memory devices; one or more storage devices; one or more interconnects; one or more device interfaces; one or more network interface devices; one or more servers; or one or more computing platforms.

16. A method comprising:
modifying at least one connection between microservices based on telemetry data.

17. The method of claim 16, wherein the at least one connection between microservices comprises one or more of: chip-to-chip communications, die-to-die communications, packet-based communications, communications over a device interface, or fabric-based communications.

18. The method of claim 16, wherein the telemetry data comprises one or more of: time-to-completion of a microservice, latency of communications between microservices, capacity of one or more processors, capacity of one or more memory devices, or network bandwidth utilization.

19. The method of claim 16, wherein the modifying at least one connection between microservices based on telemetry data is also based at least on at least one service level agreement (SLA) parameter associated with the microservices.

20. The method of claim 16, wherein the modifying at least one connection between microservices based on telemetry data comprises modifying a hardware resource that is to execute one or more of the microservices.

21. At least one non-transitory computer-readable medium comprising instructions stored thereon, that if executed by one or more processors, cause the one or more processors to:
dynamically select composition of an application between monolithic implementation and two or more microservices based on telemetry data.

22. The at least one non-transitory computer-readable medium of claim 21, comprising instructions stored thereon, that if executed by one or more processors, cause the one or more processors to:
based on composition of an application as two or more microservices, adjust at least one connection between microservices based on telemetry data.

23. The at least one non-transitory computer-readable medium of claim 22, comprising instructions stored thereon, that if executed by one or more processors, cause the one or more processors to:
configure a switch to perform forwarding of communications between microservices based on the adjusted at least one connection between microservices.
